(19) United States
(12) Patent Application Publication
(10) Pub. No.: US 2003/0213764 A1
(43) Pub. Date: Nov. 20, 2003

(54) Connecting member for constructing arch frame

(76) Inventor: Whiter Shieh, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/147,875

(22) Filed: May 20, 2002

(51) Int. Cl. F21S 13/14

(52) U.S. Cl. 211/189; 362/252

(57) ABSTRACT

An arch frame for supporting a light string includes two arch-shaped support bars. Each support inclues a number of T-shaped elements having aligned first and second branches and a perpendicular third branch. Adjacent T-shaped elements are connected together by connection beams having opposite ends respectively and releasably coupled to the first and second branches of the T-shaped elements. A cross stick has opposite ends respectively and releasably connected to the third branches of opposite T-shaped elements of the two arch-shaped bars to fix the support bars together. Each T-shaped element further includes a peg extending in a direction substantially opposite to the third branch for engaging the wires of the light string so as to support the light string on the arch frame.

### BACKGROUND OF THE INVENTION

1. Field of the Invention

The present invention relates generally to a frame for supporting a decorative light string, and in particular to an arch frame structure for supporting the light string.

2. Description of the Prior Art

Decorative light strings are commonly used in celebrations and festivals. The light string usually comprises electrical wires to which a number of lamp sockets are mounted. Lamp bulbs are received in the lamp sockets and powered by the electrical wires. Since the wires are not stiff enough to support themselves, a support frame is commonly employed. Such a support frame may be simply a tree or a window. An arch frame for supporting the light string is known in for example U.S. Pat. No. 6,158,700. However, the conventional arch frame is not easy to be reassembled and requires quite a space in storage and transportation.

Thus, it is desired to have a light string support frame having a collapsible structure for overcoming the above deficiency.

### SUMMARY OF THE INVENTION

A primary object of the present invention is to provide an arch frame for supporting a light string, the arch frame being collapsible whereby the arch frame occupies a small space in storage and transportation.

Another object of the present invention is to provide a collapsible supporting frame comprised of a number of connector elements that allow general public to reconstruct the supporting frame in different forms.

A further object of the present invention is to provide a collapsible supporting frame comprised of a number of wire retention elements for effectively securing the wires on the frame.

To achieve the above objects, in accordance with the present invention, there is provided an arch frame for supporting a light string, the arch frame comprising two arch-shaped bars, each comprised of a number of T-shaped elements having aligned first and second branches and a perpendicular third branch. Adjacent T-shaped elements are connected together by connection beams having opposite ends respectively and releasably coupled to the first and second branches of the T-shaped elements. A cross stick has opposite ends respectively and releasably connected to the third branches of opposite T-shaped elements of the two arch-shaped bars to fix the arch-shaped bars together. Each T-shaped element may form a peg extending in a direction substantially opposite to the third branch for engaging the wires of the light string so as to support the light string on the arch frame. The peg has an expanded free end for effectively retaining the wires on the frame.

### BRIEF DESCRIPTION OF THE DRAWINGS

The present invention will be apparent to those skilled in the art by reading the following description of preferred embodiments thereof, with reference to the attached drawings, in which:

FIG. 1 is a perspective view of an arch frame constructed in accordance with the present invention;

FIG. 2 is a perspective view of a T-element of the arch frame of the present invention;

FIG. 3 is a perspective view of an arc T-element of the arch frame of the present invention;

FIG. 4 is a perspective view of a T-element in accordance with another embodiment of the present invention;

FIG. 5 is a perspective view of a portion of the arch frame of the present invention showing wires entangling on peg of the T-element; and

FIG. 6 is an enlarged view of encircled portion of FIG. 5.

### DETAILED DESCRIPTION OF THE PREFERRED EMBODIMENTS

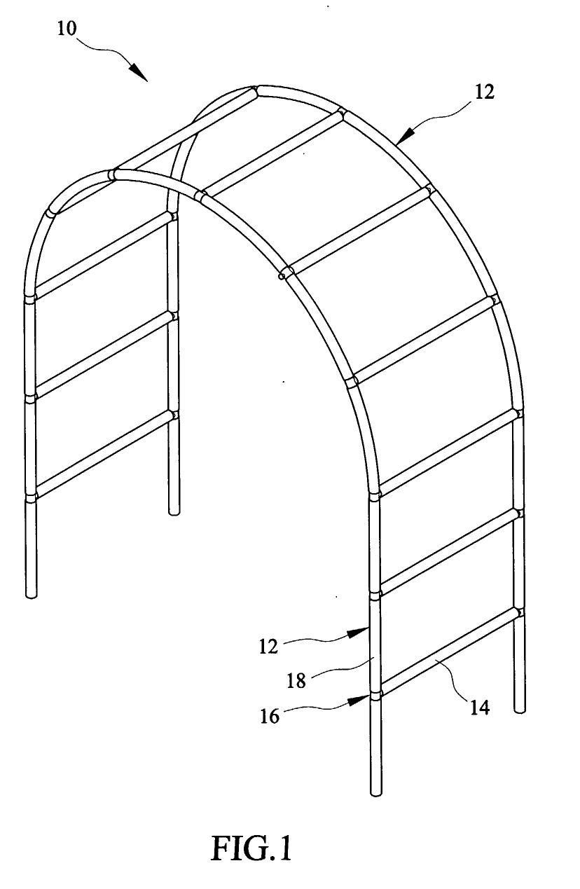

With reference to the drawings and in particular to FIG. 1, an arch frame constructed in accordance with the present invention, generally designated with reference numeral 10, comprising a pair of arch-shaped bars 12 supported on a fixed surface (not shown), such as ground. The arch-shaped bars 12 are spaced from each other by connected by a number of cross sticks 14. Preferably, the cross sticks 14 are equally spaced along the arch-shaped bars 12, but not necessary to be so.

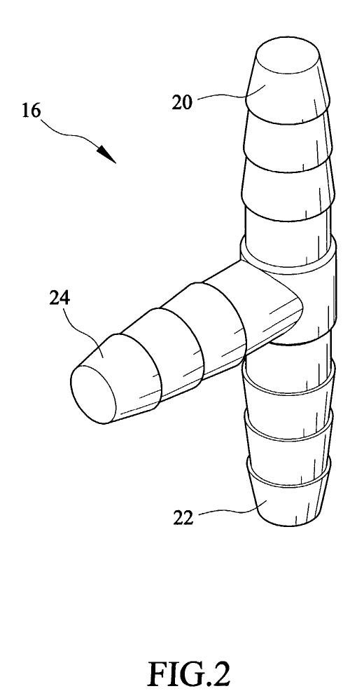

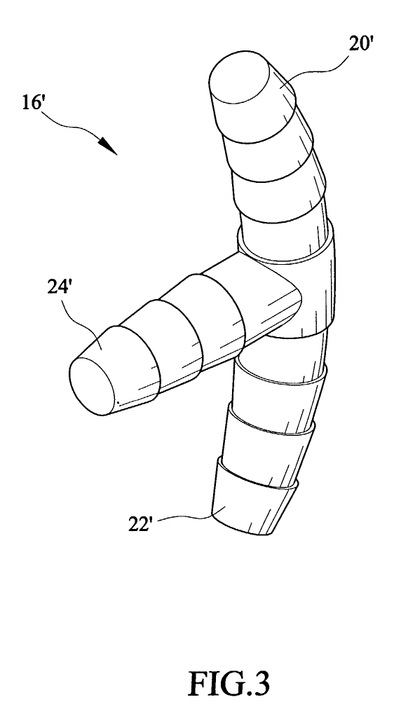

Also referring to FIGS. 2 and 3, each arch-shaped bar 12 comprises a number of T-elements 16 and straight beams 18 connected between adjacent T-elements 16. Each T-element 16, as suggested by the name thereof, has a T-shape having three branches 20, 22, 24 among which branches 20, 22 are in alignment with each other while branch 24 is substantially perpendicular to the branches 20, 22. Each beam 18 has opposite ends (not labeled) respectively and releasably coupled to the first and second branches 20, 22 of adjacent T-elements 16. The third branch 24 is releasably coupled to an end of the associated cross stick 14. The releasable engagement between the T-elements 16 and the beams 18 (as well as the sticks 14) allows the arch frame 10 to be separated.

To comply with the arch-shape, the first and second branches 20, 22 of some of the T-elements 16 are made arculated as particularly shown in FIG. 3 (designated with reference numeral 16′) and are referred to as arc T-elements hereinafter. The beams connected between the arc T-elements 16′ are arculated too. That is, each arc T-elements 16′ includes three branches 20′, 22′, 24′ among which branches 20′, 22′ are in alignment with each other while branch 24′ is substantially perpendicular to the branches 20′, 22′.

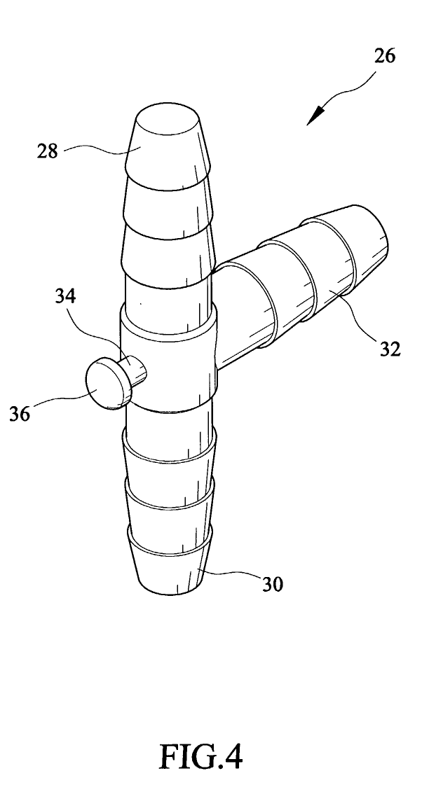

Further referring to FIG. 4, a T-element in accordance with another embodiment of the present invention and designated with reference numeral 26 has a T-shape comprising first 28, second 30, and third 32 branches similar to the T-element 16 with reference to FIG. 2. The T-element 26 further comprises wire retention means which in the embodiment illustrated comprises a peg 34 extending in a direction substantially opposite to the third branch 32. Preferably, the peg 34 has an expanded free end 36.

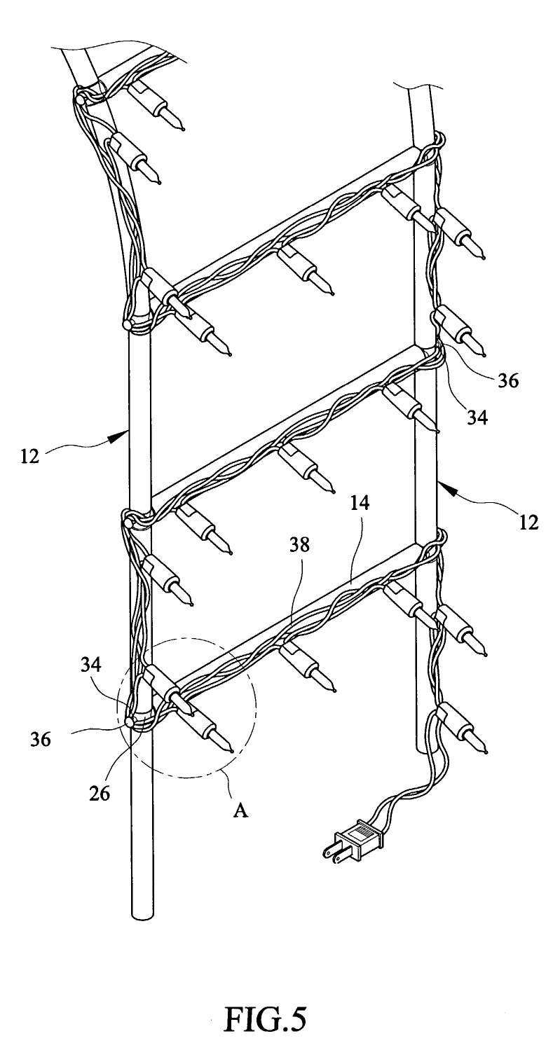

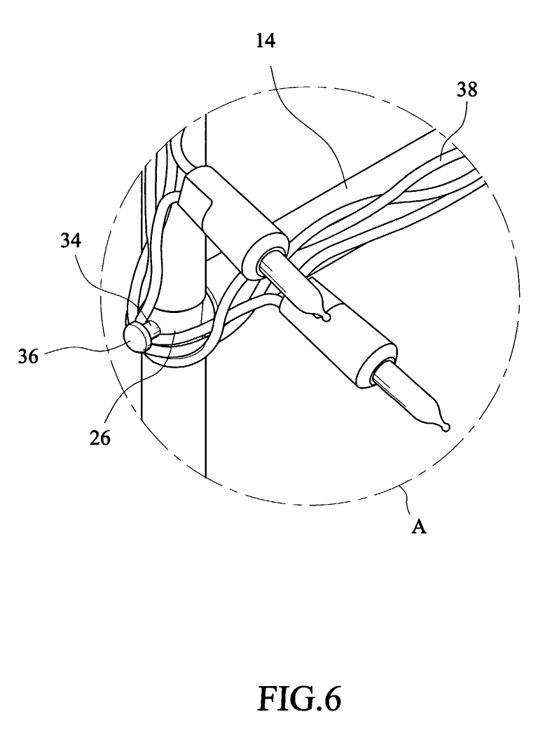

Also referring to FIGS. 5 and 6, a wire 38 entangling around the T-element 26 by engaging the peg 34 and being retained by the expanded end 36 of the peg 34. By this way, the wire 38, which can be the wire of a light sting, can be securely and simply attached to the support frame 10.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A light string support frame comprising two support bars adapted to be positioned on and supported by a fixed surface, each support bar comprising:
a plurality of T-shaped elements having a first branch, a second branch opposite to the first branch, and a third branch perpendicular to the first branch and the second branch;
a plurality of connection beams each having opposite ends respectively and releasably coupled to the first branch and the second branch of adjacent T-shaped elements; and
a plurality of cross sticks each having opposite ends respectively and releasably coupled to the third branches of the T-shaped elements of the two support bars to fix the support bars together.

2. The light string support frame as claimed in claim 1, wherein the support bars are made arch-shaped whereby the support frame is an arch frame.

3. The light string support frame as claimed in claim 2, wherein at least one selected T-shaped element comprises arculated first and second branches, the beam connected to the selected T-shaped element being selectively arculated.

4. The light string support frame as claimed in claim 1, wherein the T-shaped element comprises a peg.

5. The light string support frame as claimed in claim 4, wherein the peg extends in a direction substantially opposite to the third branch.

6. The light string support frame as claimed in claim 4, wherein the peg has an expanded free end for effectively retaining wires of a light string.
